(19) United States
(12) Patent Application Publication
(10) Pub. No.: US 2026/0326407 A1
(43) Pub. Date: Oct. 22, 2026

(54) CARDBOARD BOX FOLDING MECHANISM

(71) Applicant: HANGZHOU HONGBA TRADING CO., LTD, Hangzhou (CN)

(72) Inventors: Bifeng GAO, Hangzhou (CN); Fei HUANG, Hangzhou (CN); Dingju GAO, Hangzhou (CN)

(21) Appl. No.: 19/697,572

(22) Filed: Jun. 4, 2026

Related U.S. Application Data
(63) Continuation of application No. PCT/CN2024/136584, filed on Dec. 4, 2024.

(30) Foreign Application Priority Data
Dec. 4, 2023 (CN) 202323287527.0
Feb. 20, 2024 (CN) 202420310086.7
Jul. 19, 2024 (CN) 202421726431.1
Nov. 14, 2024 (CN) 202422781674.1

(51) Int. Cl. B31B 50/34; B31B 105/00

(52) U.S. Cl. CPC B31B 50/34; B31B 2105/00

(57) ABSTRACT

A cardboard box folding mechanism includes: a folding guide frame and a support structure connected to the folding guide frame. The support structure includes a folding guide wheel component. The folding guide frame has four sides, and at least one folding guide wheel is provided on at least one side. The folding guide wheel component is movably assembled with the folding guide frame to selectively adjust the number and position of the folding guide wheel component. By providing a folding guide wheel component on the folding guide frame, the sliding friction between the side wall of the cardboard box to be folded and the folding guide wheel component is converted into rolling friction, thereby reducing the problem of indentations caused by the support structure squeezing the cardboard box during folding.

### CROSS REFERENCE TO RELATED APPLICATIONS

The present application is a continuation-application of International (PCT) Patent Application No. PCT/CN 2024/136584 filed on Dec. 4, 2024, which claims priority benefits to Chinese Patent Disclosure No. 2023232875270 filed on Dec. 4, 2023, NO. 2024203100867 filed on Feb. 20, 2024, NO. 2024217264311 filed on Jul. 19, 2024, and NO. 2024227816741 filed on Nov. 14, 2024, the contents of which are incorporated herein by reference.

### TECHNICAL FIELD

The present disclosure relates to cardboard box folding tools, and in particular to a cardboard box folding mechanism.

### BACKGROUND

The cardboard box folding mechanism of related arts typically includes a folding frame and a support structure mounted on the folding frame. During the cardboard box folding process, the unfolded cardboard box is first placed on the folding mechanism, and then pressed down to fold the box under the guidance and support of the support structure.

### SUMMARY

A cardboard box folding mechanism comprising: a folding guide frame and a support structure connected to the folding guide frame, the support structure including a folding guide wheel component. The folding guide frame has four sides, each of the four sides is provided with the at least one folding guide wheel component, and the at least one folding guide wheel is movably assembled with the folding guide frame.

### BRIEF DESCRIPTION OF THE DRAWINGS

The drawings in the specification, which constitute a part of the present disclosure, are used to provide further understanding of the present disclosure. The illustrative embodiments of the present disclosure and their descriptions are for explanation purposes and do not constitute improper limitations on the present disclosure.

FIG. 1 is a perspective view of a first structure of a cardboard box folding mechanism according to some embodiments of the present disclosure.

FIG. 2 is a perspective view of a second structure of the cardboard box folding mechanism according to some embodiments of the present disclosure.

FIG. 3 is a perspective view of a third structure of the cardboard box folding mechanism according to some embodiments of the present disclosure.

FIG. 4 is a side view of the cardboard box folding mechanism according to some embodiments of the present disclosure.

FIG. 5 is a top view of the cardboard box folding mechanism according to some embodiments of the present disclosure.

FIG. 6 is a perspective view of the structure of the cardboard box folding mechanism according to some embodiments of the present disclosure.

FIG. 7 is a top view of the cardboard box folding mechanism according to some embodiments of the present disclosure.

FIG. 8 is an unfolded view of a cardboard adapted to the cardboard box folding mechanism according to some embodiments of the present disclosure.

FIG. 9 is a perspective view of the structure of the cardboard located in the cardboard box folding mechanism according to some embodiments of the present disclosure.

FIG. 10 is a perspective view of the cardboard folding process according to some embodiments of the present disclosure.

### DETAILED WAY

The present disclosure will be described in detail below with reference to the accompanying drawings and in conjunction with examples. Each example is provided by way of explanation of the present disclosure and is not intended to limit the present disclosure. Indeed, those skilled in the art will appreciate that modifications and variations may be made herein without departing from the scope or spirit of the present disclosure. For example, a feature illustrated or described as part of some embodiments may be used in another embodiment to produce yet another embodiment. Therefore, it is intended that the present disclosure encompasses such modifications and variations as come within the scope of the appended claims and their equivalents.

In the description of the present disclosure, terms such as “longitudinal,” “transverse,” “upper,” “lower,” “front,” “rear,” “left,” “right,” “vertical,” “horizontal,” “top,” and “bottom” indicate orientations or positional relationships based on the orientations or positional relationships shown in the accompanying drawings. These terms are provided solely for ease of description and do not require that the present disclosure be constructed or operated in a specific orientation. Therefore, they should not be construed as limiting the present disclosure. The terms “connected,” “connection,” and “arranged” used in the present disclosure should be interpreted broadly. For example, they can refer to fixed or detachable connections; direct or indirect connections through intermediate components; wired electrical connections, radio connections, or wireless communication signal connections. Those skilled in the art will understand the specific meanings of these terms based on the specific circumstances.

The accompanying drawings illustrate one or more examples of the present disclosure. The detailed description uses numbers and letters to refer to features in the drawings. Like or similar numbers in the drawings and description have been used to refer to like or similar parts of the present disclosure. As used herein, the terms “first,” “second,” and “third” are used interchangeably to distinguish one component from another and are not intended to indicate the location or importance of individual components.

During the pressing process, the outer wall of the cardboard box often comes into contact with and rubs against the support structure, easily causing indentations or even damage to the outer wall.

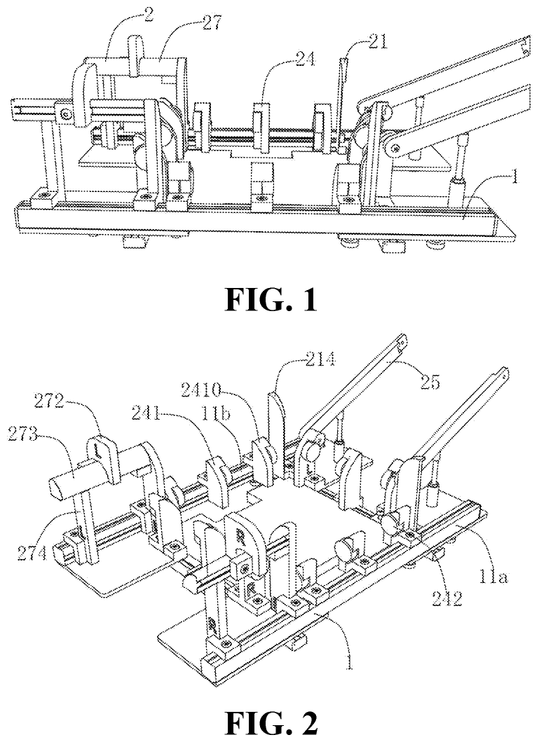

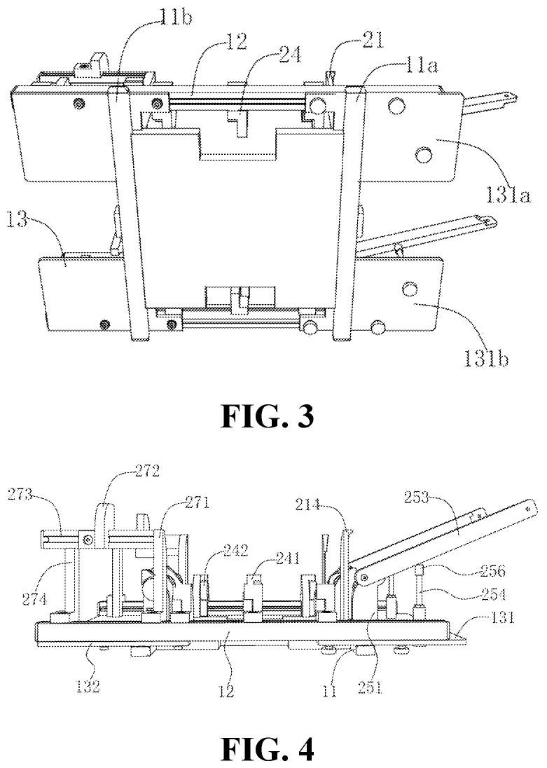

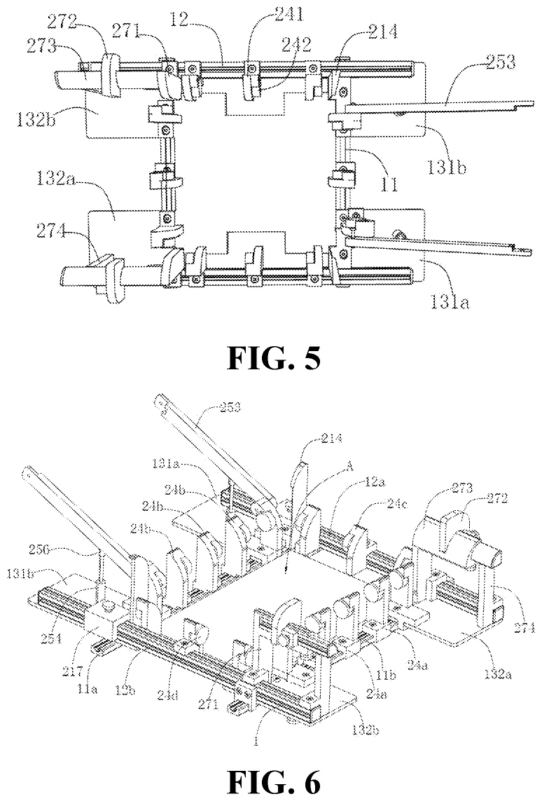

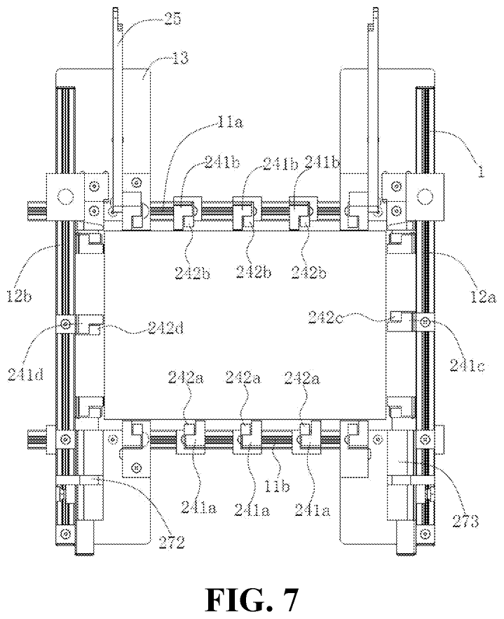

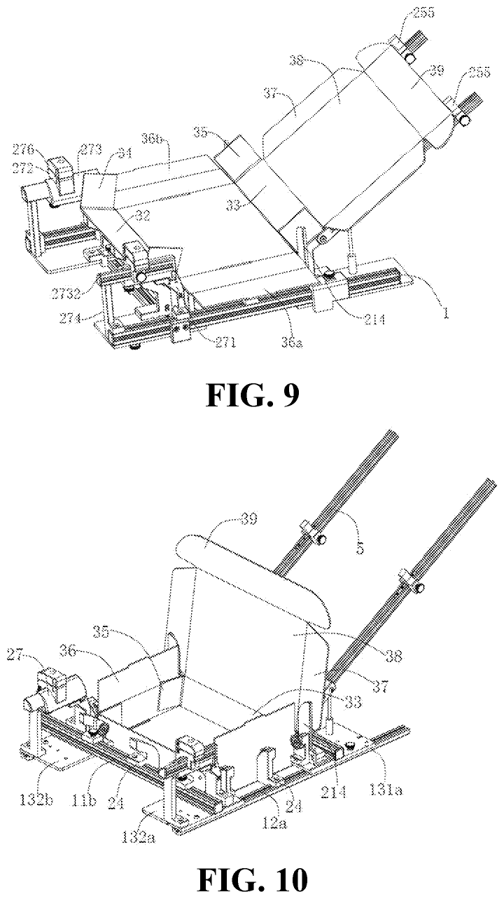

As shown in FIGS. 1 to 10, some embodiments provide a cardboard box folding mechanism that is mainly used to fold cardboard boxes, simplifying the folding operation and improving the folding efficiency. The following description uses an cardboard box as the folding object of this cardboard box folding mechanism.

As shown in FIGS. 1 to 5, in some embodiments, the cardboard box folding mechanism includes: a folding guide frame 1 and a support structure 2. The folding guide frame 1 is connected to the support structure 2. The support structure 2 includes at least one folding guide wheel component 24.

The folding guide frame 1 has four sides, and at least one folding guide wheel component 24 is provided on at least one side of the four sides. The at least one folding guide wheel component 24 is movably assembled with the folding guide frame 1, which allows the operator to selectively adjust the number and position of the at least one folding guide wheel component 24.

In some embodiments, each folding guide wheel component 24 on the guide frame 1 includes a folding guide seat 241. The folding guide seat 241 has a fixed end and a free end. The fixed end of the folding guide seat 241 is movably inserted into the guide frame 1 by screws. The free end of the folding guide seat 241 defines a guide surface 2410.

The folding guide surface 2410 is configured to guide the folding direction of the cardboard box during folding, thus providing good assistance. The fixed end of the folding guide seat 241 is movably inserted into the folding guide frame 1 by screws. The operator may remove, install, and adjust the position of the folding guide seat 241 by tightening the screws. When the side of the folding guide frame 1 is relatively long, users may choose to increase the number of the folding guide seat 241 and adjust the spacing between two adjacent folding guide seats 241 as needed, so as to achieve an improved guiding effect for folding the cardboard box with a smaller number of folding guide seats 241.

As shown in FIGS. 1 to 5, in some embodiments, the folding guide surface 2410 is either a sloped or curved surface. The sloped or curved surface design may be configured to smoothly guide corresponding parts of the cardboard box to bend during folding, reducing the chance of the folding guide seat 241 scratching the outer surface of the cardboard box during folding and improving the folding quality of the cardboard box.

In some embodiments, each folding guide wheel component 24 further includes a roller 242. The roller 242 is rotatably connected to the free end of the folding guide seat 241, and at least a portion of the outer circumferential annular surface of the roller 242 protrudes from the folding guide surface 2410. This configuration of the roller 242 is configured to convert the sliding friction into rolling friction between the cardboard box and the folding guide surface 2410, thereby reducing the possibility of the at least one folding guide wheel component 24 damaging the outer surface of the cardboard box during folding and further improving the folding quality of the cardboard box. Furthermore, the roller 242 also reduces the resistance when the cardboard box is pressed down, thereby improving the smoothness of folding.

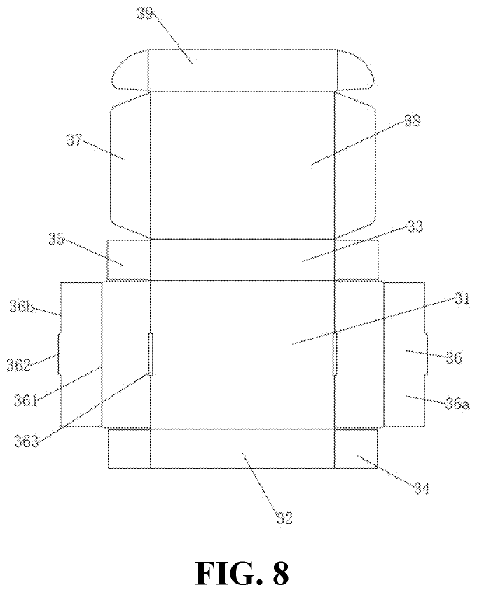

As shown in FIG. 8, in some embodiments, the cardboard box is rectangular and is formed by a cardboard 3. The cardboard 3 includes: a bottom plate 31, a front support plate 32, a rear support plate 33, two front flaps 34, two rear flaps 35, two side wings 36, two flaps 37, a top cover 38, and a closing plate 39.

The front support plate 32 and the rear support plate 33 are respectively connected to the two long sides of the bottom plate 31. The two side wings 36 respectively connected to the two short sides of the bottom plate 31. The two front flaps 34 are respectively connected to the two short sides of the front support plate 32, and the two rear flaps 35 are respectively connected to the two short sides of the rear support plate 33. Another long side of the rear support plate 33 and one long side of the closing plate 39 are respectively connected to the two long sides of the top cover 38. The two flaps 37 are respectively connected to the two short sides of the top cover 38. The positions where the bottom plate 31 is connected to the front support plate 32, the bottom plate 31 is connected to the rear support plate 33, the bottom plate 31 is connected to the two side wings 36, the front support plate 32 is connected to the two front flaps 34, the rear support plate 33 is connected to the two rear flaps 35, the rear support plate 33 is connected to the top cover 38, the top cover 38 is connected to the two wing flaps 37, and the top cover 38 is connected to the lid panel 39 are each provided with a folding line. In addition, the side wings 36 includes a right wing 36a and a left wing 36b.

As shown in FIGS. 1 to 5 and FIG. 8, in some embodiments, the support structure 2 also includes a support member 21 and a stop assembly 27. The support member 21 includes a folding guide engaging plate 214 disposed on each of two sides of the rear end of the folding guide frame 1.

Each stop assembly 27 includes a fixed baffle 271. A stop block 272 is disposed at the upper end of each fixed baffle 271. A stop block slide rail 273 is disposed between each stop block 272 and the corresponding one fixed baffle 271. A support column 274, which is screwed and pressed into a longitudinal support slide rail 12, is provided at the rear end of each stop block slide rail 273. The lower end of the support column 274 is provided with a front bottom plate 132 that is screw-pressed fixed to a transverse support slide rail 11. The longitudinal support slide rail 12 is screwed to the support column 274. Consequently, two stop block slide rails 273 are configured to support and guide the two front flaps 34. The two folding guide engaging plates 214 are configured to support and guide the two rear flaps 35.

Furthermore, the rear end of each of the two folding guide engaging plates 214 has a pressing assembly 25. Each pressing assembly 25 has an adjusting screw that may be operated by hands and presses against and engages the transverse support slide rail 11. Each pressing assembly 25 is fixed and disassembled with the transverse support slide rail 11 by the adjusting screw. Each pressing assembly 25 includes a pressing rod 253 mounted on the rear bottom plate 131. An ear plate seat 251 is provided between the front end of the pressing rod 253 and the rear bottom plate 131, and is pin-connected and fixed to the pressing rod 253. A support adjusting screw 254 is provided between the rear end of the pressing rod 253 and the rear bottom plate 131 to provide height support for the pressing rod 253. A buffer rubber cap 256 is provided between the upper end of the support adjusting screw 254 and the pressing rod 253, and is sleeved with the support adjusting screw 254.

As shown in FIGS. 6 to 10, in some embodiments, the folding guide frame 1 is a sliding rail frame. The support structure 2 is slidably connected to the folding guide frame 1. The size of the folding area A may be adjusted by adjusting the size of the quadrilateral area enclosed in the middle of the folding guide frame 1 and the position of the support structure 2 on the folding guide frame 1, thereby realizing the auxiliary folding of various sizes of cardboard boxes.

The folding guide frame 1 includes two mutually parallel transverse support slide rails 11 and two mutually parallel longitudinal support slide rails 12. The two transverse support slide rails 11 and the two longitudinal support slide rails 12 are respectively located in upper and lower planes and are arranged in a perpendicularly intersecting pattern. A connecting plate 13 is provided at each intersection point of each transverse support slide rail 11 and each longitudinal support slide rail 12. At the intersection points, each connecting plate 13 is slidingly connected to the corresponding one transverse support slide rail 11 and the corresponding one longitudinal support slide rail 12. Each connecting plate 13 may be selectively fixed on the corresponding one transverse support slide rail 11 and the corresponding one longitudinal support slide rail 12. With this arrangement, by adjusting the positions of the four connecting plates 13 on the corresponding two transverse support slide rails 11 and two longitudinal support slide rails 12, the size of the quadrilateral enclosed between the two transverse support slide rails 11 and the two longitudinal support slide rails 12 can be changed, thereby constructing a two-dimensional sliding platform.

In some embodiments, the two transverse support slide rails 11 and the two longitudinal support slide rails 12 form the four sides of the folding guide frame 1. The at least one folding guide wheel component 24 is installed on each of four sides of the folding guide frame 1. The two transverse support slide rails 11 are respectively configured as a first transverse support slide rail 11a and a second transverse support slide rail 11b. The two longitudinal support slide rails 12 are respectively configured as a first longitudinal support slide rail 12a and a second longitudinal support slide rail 12b. The four connecting plates 13 are respectively configured as two rear bottom plates 131 and two front bottom plates 132. The two rear bottom plates 131 are respectively configured as a first rear bottom plate 131a and a second rear bottom plate 131b; the two front bottom plates 132 are respectively configured as a first front bottom plate 132a and a second front bottom plate 132b.

In some embodiments, the first transverse support slide rail 11a is connected via bolts to the first rear bottom plate 131a and the second rear bottom plate 131b, and the second transverse support slide rail 11b is connected via bolts to the first front bottom plate 132a and the second front bottom plate 132b. The first longitudinal support slide rail 12a is connected to the first rear bottom plate 131a and the first front bottom plate 132a, and the second longitudinal support slide rail 12b is connected to the second rear bottom plate 131b and the second front bottom plate 132b. When the bolts are loosened, two adjacent connecting plate 13 may move together in the transverse or longitudinal direction. After tightening the bolts, each connecting plate 13 is secured between one corresponding transverse support slide rail 11 and one corresponding longitudinal support slide rail 12, forming a stable folding guide frame 1.

As shown in FIG. 10, in some embodiments, the first rear bottom plate 131a is located above the first longitudinal support slide rail 12a and below the first transverse support slide rail 11a. The second rear bottom plate 131b is located above the second longitudinal support slide rail 12b and below the first transverse support slide rail 11a. The first front bottom plate 132a is located above the first longitudinal support slide rail 12a and below the second transverse support slide rail 11b. The second front bottom plate 132b is located above the second longitudinal support slide rail 12b and below the second transverse support slide rail 11b.

As shown in FIGS. 1 to 9, in some embodiments, the first rear bottom plate 131a is located below the first longitudinal support slide rail 12a and above the first transverse support slide rail 11a. The second rear bottom plate 131b is located below the second longitudinal support slide rail 12b and above the first transverse support slide rail 11a. The first front bottom plate 132a is located below the first longitudinal support slide rail 12a and above the second transverse support slide rail 11b. The second front bottom plate 132b is located below the second longitudinal support slide rail 12b and above the second transverse support slide rail 11b.

As shown in FIGS. 6 to 10, each folding guide wheel component 24 includes: a first folding guide wheel 24a, a second folding guide wheel 24b, a third folding guide wheel 24c, and a fourth folding guide wheel 24d.

At least one first folding guide wheel 24a is provided. Each first folding guide wheel 24a is movably mounted on the second transverse support slide rail 11b. The at least one first folding guide wheel 24a is located between the first front bottom plate 132a and the second front bottom plate 132b. At least one second folding guide wheel 24b is provided. Each second folding guide wheel 24b is movably mounted on the first transverse support slide rail 11a. The at least one second folding guide wheel 24b is located between the first rear bottom plate 131a and the second rear bottom plate 131b. At least one third folding guide wheel 24c is provided. Each third folding guide wheel 24c is movably mounted on the first longitudinal support slide rail 12a. The at least one third folding guide wheel 24c is located between the first front bottom plate 132a and the first rear bottom plate 131a. At least one fourth folding guide wheel 24d is provided. The at least one fourth folding guide wheel 24d is movably mounted on the second longitudinal support slide rail 12b. Each fourth folding guide wheel 24d is located between the second front bottom plate 132b and the second rear bottom plate 131b.

The at least one first folding guide wheel 24a and the at least one second folding guide wheel 24b are respectively configured to support and guide the front support plate 32 and the rear support plate 33. The at least one third folding guide wheel 24c and the at least one fourth folding guide wheel 24d are respectively configured to support and guide the right wing 36a and the left wing 36b. When the box to be folded is large, the number of the first folding guide wheel 24a, the second folding guide wheel 24b, the third folding guide wheel 24c, and the fourth folding guide wheel 24d may be increased according to the actual situation to improve the support and guiding effect.

In some embodiments, each first folding guide wheel 24a includes: a first folding guide seat 241a and a first roller 242a. The fixed end of the first folding guide seat 241a is detachably connected to the second transverse support slide rail 11b by fastening screws, and the first roller 242a is rotatably mounted on the free end of the first folding guide seat 241a. A portion of the outer circumferential annular surface of the first roller 242a protrudes from the folding guide surface 2410 of the first folding guide seat 241a. Furthermore, each second folding guide wheel 24b includes: a second folding guide seat 241b and a second roller 242b. The fixed end of the second folding guide seat 241b is detachably connected to the first transverse support slide rail 11a by fastening screws, and the second roller 242b is rotatably mounted on the free end of the second folding guide seat 241b. A portion of the outer circumferential annular surface of the second roller 242b protrudes from the folding guide surface 2410 of the second folding guide seat 241b. Each third folding guide wheel 24c includes: a third folding guide seat 241c and a third roller 242c. The fixed end of the third folding guide seat 241c is detachably connected to the first longitudinal support slide rail 12a by fastening screws, and the third roller 242c is rotatably mounted on the free end of the third folding guide seat 241c. A portion of the outer circumferential annular surface of the third roller 242c protrudes from the folding guide surface 2410 of the third folding guide seat 241c. Moreover, Each fourth folding guide wheel 24d includes: a fourth folding guide seat 241d and a fourth roller 242d. The fixed end of the fourth folding guide seat 241d is detachably connected to the second longitudinal support slide rail 12b by fastening screws, and the fourth roller 242d is rotatably mounted on the free end of the fourth folding guide seat 241d. A portion of the outer circumferential annular surface of the fourth roller 242d protrudes from the folding guide surface 2410 of the fourth folding guide seat 241d.

Each first folding guide 241a, each second folding guide 241b, each third folding guide 241c, and each fourth folding guide 241d are respectively configured to fold the front support plate 32, the rear support plate 33, the right wing 36a, and the left wing 36b of the cardboard. Each first roller 242a, each second roller 242b, each third roller 242c, and each fourth roller 242d are respectively configured to fold the front support plate 32, the rear support plate 33, the right wing 36a, and the left wing 36b into place. The bending of the cardboard 3 is a necessary operation before the bottom plate 31 is pressed down. The bending operation may also position the cardboard 3, so that the bottom plate 31 is directly above the folding area A, thereby facilitating the subsequent folding operation of the cardboard 3.

In some embodiments, each stop block slide rail 273 and each folding guide engaging plate 214 are both higher than each folding guide wheel component 24. When the cardboard 3 is pressed down, the two front flaps 34 and the two rear flaps 35 are folded before the front support plate 32, the rear support plate 33 and the two side wings 36. This is the first stage of the cardboard box folding process.

In some embodiments, the first fold guide 241a and the second fold guide 241b have the same height. The third fold guide 241c and the fourth fold guide 241d have the same height. The heights of the first fold guide 241a and the second fold guide 241b are both greater than the heights of the third fold guide 241c and the fourth fold guide 241d. During the folding process of the cardboard 3, the first fold guide 241a and the second fold guide 241b abut against the cardboard 3 before the third fold guide 241c and the fourth fold guide 241d, so that the front support plate 32 and the rear support plate 33 of the cardboard 3 are bent before the side wings 36. This is the second stage of the cardboard box folding process.

As shown in FIGS. 6 to 10, the first roller 242a, the second roller 242b, the third roller 242c, and the fourth roller 242d have the same diameter. The axial height of the third roller 242c and the fourth roller 242d is the same. The axial height of the third roller 242c and the fourth roller 242d is greater than that of the first roller 242a. The axial height of the third roller 242c and the fourth roller 242d is less than that of the second roller 242b. During the pressing down of the bottom plate 31, the rear support plate 33, the side wing 36, and the front support plate 32 will be folded into place sequentially. Compared with the synchronous folding method, the rear support plate 33, the side wing 36, and the front support plate 32 will be folded into place in sequence, which may not only reduce the mutual interference between the various parts of the cardboard 3 during the folding of the cardboard box, but also effectively improve the folding efficiency.

In some embodiments, the first roller 242a, the third roller 242c, and the second roller 242b may also be configured to have the same axial height and progressively increasing diameters, and with the third roller 242c having the same diameter as the fourth roller 242d. This configuration allows for different folding sequences of the rear support plate 33, the side wings 36, and the front support plate 32.

During the folding process of the cardboard box, when the cardboard 3 is placed on the cardboard box folding mechanism, the bottom plate 31 is located above the folding area A. The front support plate 32 and the rear support plate 33 respectively abut against the folding guide arc surface 2410 on the first folding guide seat 241a and the folding guide arc surface 2410 on the second folding guide seat 241b. The two rear flaps 35 abut against the two folding guide engaging plates 214, and the two front flaps 34 abut against the two stop block slide rails 273, respectively. The right wing 36a and the left wing 36b abut against the corresponding third folding guide wheel 24c and the corresponding fourth folding guide wheel 24d, respectively.

When folding the cardboard box, the cardboard 3 is initially pressed down and positioned, so that the ends of the two side wings 36 near the front flaps 34 move downwards along the front end of the stop assembly 27, thereby correcting the position of the cardboard 3 and facilitating the positioning of the further folding operations. Since the two stop block slide rails 273 and the two folding guide engaging plates 214 are both higher than the at least one folding guide wheel component 24, when the cardboard 3 is placed on the cardboard box folding mechanism and initially pressed down and positioned, the two front flaps 34 and the two rear flaps 35 are respectively bent preferentially before the front support plate 32 and the rear support plate 33.

Subsequently, the bottom plate 31 is further pressed down. The first folding guide seat 241a and the second folding guide seat 241b have the same height, and the third folding guide seat 241c and the fourth folding guide seat 241d have the same height, and the heights of the first folding guide seat 241a and the second folding guide seat 241b are both greater than the heights of the third folding guide seat 241c and the fourth folding guide seat 241d. This folding mechanism ensures that the front support plate 32 and the rear support plate 33 are bent before the side wings 36, and that a portion of the front flap 34 and a portion of the rear flap 35 are initially positioned between the two side wings 36, so that the front flap 34 and the rear flap 35 may be folded into place subsequently.

Furthermore, the bottom plate 31 is pressed down. Since the third roller 242c and the fourth roller 242d have the same axial height, and both of which are greater than the axial height of the first roller 242a and less than the axial height of the second roller 242b, the right wing 36a and the left wing 36b will fold into place before the front support plate 32 during the further pressing down process. During the continuous pressing down of the bottom plate 31, a portion of each front flap 34 and a portion of each rear flap 35 are initially positioned between the two wings 36, so that each front flap 34 and each rear flap 35 may fold into place subsequently, thus avoiding interference with the folding of each front flap 34 and each rear flap 35.

After the bottom plate 31 is pressed down into place, the front support plate 32 and the rear support plate 33 are bent to be perpendicular to the bottom plate 31. The two front flaps 34 and the two rear flaps 35 are respectively perpendicular to the front support plate 32, the rear support plate 33, and the bottom plate 31. The two side wings 36 are perpendicular to the bottom plate 31, and the two side wings 36 respectively enclose the two front flaps 34 and the two rear flaps 35 on inner sides. Then, the two side wings 36 are folded along the side wing fold line 361, and the locking part 362 is inserted into the locking groove 363, so that the two front flaps 34 and the two rear flaps 35 are clamped in the corresponding side wings 36. Thus, the part of the cardboard box excluding the top cover 38 and the closing 39 is folded.

Analysis reveals that this application discloses a cardboard box folding mechanism. By setting the folding guide wheel component on the folding guide frame, the sliding friction between the side wall of the cardboard box to be folded and the folding guide wheel component is converted into rolling friction, thereby reducing the problem of indentations caused by the cardboard box being squeezed by the supporting structure during the folding process. This cardboard box folding mechanism solves the problem that the outer wall of the cardboard box is usually squeezed and rubbed against the supporting structure during the pressing process, which easily causes indentations or even damage to the outer wall of the cardboard box. The advantages include a compact structure, convenient adjustment, time and labor saving, strong stability in use, and minimal damage to the cardboard box.

As shown in the above description, the embodiments of the present invention achieve the following technical effects.
1) The folding guide surface 2410 guides the folding direction of the cardboard box during folding, thus providing good assistance. The fixed end of the folding guide base 241 is movably inserted into the folding guide frame 1 by screws. The operator may disassemble and adjust the position of the folding guide base 241 by turning the screws. When the side of the folding guide frame 1 is long, the user may choose to increase the number of folding guide bases 241 and adjust the spacing between adjacent folding guide bases 241 according to the usage requirements, so as to achieve a better guiding effect when folding the cardboard box with a smaller number of folding guide bases 241.
2) The roller 242 may convert the sliding friction between the cardboard box and the folding guide surface 2410 into rolling friction, thereby reducing the probability of the at least one folding guide wheel component 24 damaging the outer surface of the cardboard box when folding, and further improving the folding quality of the cardboard box.
3) By designing the first folding guide wheel 24a, the second folding guide wheel 24b, the third folding guide wheel 24c, and the fourth folding guide wheel 24d with different heights, the rear support plate 33, the side wings 36, and the front support plate 32 may be folded sequentially. Compared to synchronous folding, the rear support plate 33, the side wings 36, and the front support plate 32 are folded into place in sequence, which not only reduces mutual interference between different parts of the cardboard 3 during the folding process of the cardboard box, but also effectively improves the folding efficiency.

The above descriptions are merely some embodiments of the present disclosure and are not intended to limit the present disclosure. Various modifications and changes may be made to the present disclosure by those skilled in the art. Any modifications, equivalent substitutions, improvements, etc., made within the spirit and principles of the present disclosure, shall fall within the scope of protection of the present disclosure.

1. A cardboard box folding mechanism comprising: a folding guide frame and a support structure connected to the folding guide frame, wherein the support structure comprises at least one folding guide wheel component;
the folding guide frame comprises four sides, each of the four sides is provided with the at least one folding guide wheel component, the at least one folding guide wheel component is movably assembled with the folding guide frame.

2. The cardboard box folding mechanism according to claim 1, wherein each of the at least one folding guide wheel component comprises a folding guide seat, each folding guide seat has a fixed end and a free end, the fixed end of each folding guide seat is movably assembled with the folding guide frame, and the free end of each folding guide seat is defined with a folding guide surface.

3. The cardboard box folding mechanism according to claim 2, wherein each folding guide surface is an inclined surface or an arc surface.

4. The cardboard box folding mechanism according to claim 2, wherein a roller is rotatably connected to the free end of each folding guide seat, and at least a portion of an outer circumferential annular surface of each roller protrudes from the corresponding folding guide surface.

5. The cardboard box folding mechanism according to claim 1, wherein the folding guide frame comprises: two parallel transverse support slide rails and two parallel longitudinal support slide rails, the two transverse support slide rails and the two longitudinal support slide rails are respectively located in two parallel planes and intersect each other to form four intersections; each intersection is provided with a connecting plate, each connecting plate is located between one of the two transverse support slide rails and one of the two longitudinal support slide rails, each connecting plate is slidably connected to the corresponding one of the two transverse support slide rails and the corresponding one of the two longitudinal support slide rails, and each connecting plate is configured to fix a position on the corresponding one of the two transverse support slide rails and the corresponding one of the two longitudinal support slide rails; and
the two transverse support slide rails and the two longitudinal support slide rails form the four sides of the folding guide frame.

6. The cardboard box folding mechanism according to claim 5, wherein the connecting plate comprises two rear bottom plates and two front bottom plates, the two rear bottom plates and the two front bottom plates are arranged opposite to each other; the two rear bottom plates comprise a first rear bottom plate and a second rear bottom plate, and the two front bottom plates comprise a first front bottom plate and a second front bottom plate.

7. The cardboard box folding mechanism according to claim 6, wherein the at least one folding guide wheel component is installed on each of the four sides of the folding guide frame, and the at least one folding guide wheel component comprises:
at least one first folding guide wheel, wherein the at least one first folding guide wheel is movably mounted on one of the two transverse support slide rails and is located between the first front bottom plate and the second front bottom plate,
at least one second folding guide wheel, wherein the at least one second folding guide wheel is movably mounted on another of the two transverse support slide rails and is located between the first rear bottom plate and the second rear bottom plate,
at least one third folding guide wheel, wherein the at least one third folding guide wheel is movably mounted on one of the two longitudinal support slide rails and is located between the first rear bottom plate and the first front bottom plate, and,
at least one fourth folding guide wheel, wherein the at least one fourth folding guide wheel is movably mounted on another of the two longitudinal support slide rails and is located between the second rear bottom plate and the second front bottom plate.

8. The cardboard box folding mechanism according to claim 7, wherein each of the at least one first folding guide wheel comprises: a first folding guide seat and a first roller, a fixed end of each first folding guide seat is detachably connected to one of the two transverse support slide rails by fastening screws, and each first roller is rotatably mounted on a free end of the corresponding first folding guide seat, a portion of an outer circumferential annular surface of each first roller protrudes from the folding guide surface of the corresponding first folding guide seat,
each of the at least one second folding guide wheel comprises: a second folding guide seat and a second roller, a fixed end of the second folding guide seat is detachably connected to another transverse support slide rail by fastening screws, the second roller is rotatably mounted on the free end of the second folding guide seat, wherein a portion of an outer circumferential annular surface of the second roller protrudes from the folding guide surface of the second folding guide seat, each of the at least one third folding guide wheel comprises: a third folding guide seat and a third roller, a fixed end of the third folding guide seat is detachably connected to one of the two longitudinal support slide rails by fastening screws, and the third roller is rotatably mounted on the free end of the third folding guide seat, wherein a portion of an outer circumferential annular surface of the third roller protrudes from the folding guide surface of the third folding guide seat, and,
each of the at least one fourth folding guide wheel comprises: a fourth folding guide seat and a fourth roller, a fixed end of the fourth folding guide seat is detachably connected to another longitudinal support slide rail by fastening screws, and the fourth roller is rotatably mounted on the free end of the fourth folding guide seat, wherein a portion of an outer circumferential annular surface of the fourth roller protrudes from the folding guide surface of the fourth folding guide seat.

9. The cardboard box folding mechanism according to claim 8, wherein a height of the at least one first folding guide seat is the same as a height of the at least one second folding guide seat, a height of the at least one third folding guide seat is the same as a height of the at least one fourth folding guide seat, and the height of the at least one first folding guide seat and the height of the at least one second folding guide seat are both higher than the height of the at least one third folding guide seat and the height of the at least one fourth folding guide seat.

10. The cardboard box folding mechanism according to claim 8, wherein a height of the third roller and a height of the fourth roller are both lower than a height of the second roller.

11. The cardboard box folding mechanism according to claim 8, wherein the height of the third roller and the height of the fourth roller are both higher than a height of the first roller.

12. The cardboard box folding mechanism according to claim 8, wherein the height of the third roller and the height of the fourth roller are the same.
